(19) United States
(12) Patent Application Publication
(10) Pub. No.: US 2012/0128114 A1
(43) Pub. Date: May 24, 2012

(54) NUCLEAR FUEL STORAGE RACK CONNECTION STRUCTURE AND CONNECTION METHOD THEREOF

(75) Inventors: Akihisa Iwasaki, Tokyo (JP); Hideyuki Morita, Tokyo (JP); Yoshitsugu Nekomoto, Tokyo (JP); Kazuo Hirota, Tokyo (JP); Daisaku Okuno, Tokyo (JP); Masaaki Nakamura, Tokyo (JP)

(73) Assignee: MITSUBISHI HEAVY INDUSTRIES, LTD., Tokyo (JP)

(21) Appl. No.: 13/387,767

(22) PCT Filed: Jan. 25, 2011
(86) PCT No.: PCT/JP2011/051338

§ 371 Date: Jan. 30, 2012

(30) Foreign Application Priority Data
Jan. 25, 2010 (JP) 2010-013255

(51) Int. Cl. G21C 19/07

(52) U.S. Cl. 376/272

(57) ABSTRACT

The nuclear fuel storage rack connection structure is used for connecting a plurality of nuclear fuel storage racks which are stored so as to be arrayed and arranged underwater inside a storage pit, with nuclear fuel assemblies being accommodated. The nuclear fuel storage rack connection structure is provided with an engagement receiving portion which is installed on an outer circumference of the nuclear fuel storage rack and which has an engagement hole opened above or an engagement groove. An engagement member is inserted and engaged with the engagement receiving portion in a vertical direction to connect the mutually adjacent nuclear fuel storage racks.

### TECHNICAL FIELD

The present invention relates to a structure for connecting nuclear fuel storage racks which are stored underwater inside a storage pit in nuclear fuel storage facilities, with nuclear fuel assemblies being accommodated, and also relates to a method for connecting the nuclear fuel storage racks.

The application concerned is to claim the right of priority to Japanese Patent Application No. 2010-013255 filed on Jan. 25, 2010, in Japan, with the content cited herewith.

### BACKGROUND ART

Spent nuclear fuels (spent nuclear fuel rods) generated, for example, in a nuclear power plant are stored and retained in nuclear fuel storage facilities. Further, the spent nuclear fuels are accommodated in vertical cells of fuel storage racks in a state of being housed as nuclear fuel assemblies in square tubes and stored inside a storage pit in the nuclear fuel storage facilities. At this time, water is pooled inside the storage pit and the nuclear fuel storage racks (nuclear fuel assemblies) including the nuclear fuel assemblies are stored underwater, by which decay heat is cooled and removed so that the decay heat is below the critical state and nuclear radiation is blocked off.

Further, conventionally, a nuclear fuel storage rack is fixed on a side wall of a storage pit by way of a support and stored in a state of being supported by the support and the storage pit. However, where the nuclear fuel storage rack is firmly fixed to the storage pit as described above, there is a fear that the support will be increased in loads at the time of a large earthquake.

For this reason, there has been proposed and put into a practice a storage method in which a nuclear fuel storage rack is not fixed to a side wall or a base plate of a storage pit (for example, refer to Patent Document 1). In this type of nuclear fuel storage facility, the nuclear fuel storage rack is placed on the bottom (base plate) of the storage pit so as to slide relatively (a sliding mechanism is provided to attain relative sliding), by which horizontal force generated in the event of an earthquake is absorbed by sliding of the nuclear fuel storage rack, in addition to attenuation effects resulting from a fluid such as water.

However, as described, where the nuclear fuel storage rack is constituted so as to slide at the time of an earthquake, that is, where a self-sustaining nuclear fuel storage rack is adopted, as shown in FIG. 23, in the event of a large earthquake, each of nuclear fuel storage racks 1 stored inside a storage pit 2 undergoes rocking or the plurality of nuclear fuel storage racks 1 stored inside the storage pit 2 are individually subjected to sliding. Thus, there is a fear that mutually adjacent nuclear fuel storage racks 1 will collide with each other inside the storage pit 2. Further, since the nuclear fuel storage racks 1 undergo rocking, there is a fear that the nuclear fuel storage racks 1 will collide against side walls and the bottom of the storage pit 2.

On the other hand, Patent Document 2 has disclosed a method in which a connecting plate is joined by using pins to connect mutually adjacent nuclear fuel storage racks.

### PRIOR ART DOCUMENTS

### Patent Documents

Patent Document 1: Japanese Published Unexamined Patent Application No. S63-128294

Patent Document 2: Japanese Published Unexamined Patent Application No. H8-334596

### SUMMARY OF THE INVENTION

### Problem to be Solved by the Invention

When used nuclear fuels are stored inside a storage pit, nuclear fuel storage racks are suspended inside the storage pit to store the nuclear fuel storage racks in the order corresponding to accommodation of the nuclear fuel assemblies. Further, at this time, the plurality of nuclear fuel storage racks are stored sequentially inside the storage pit. Also, a new nuclear fuel storage rack is stored so as to be arrayed and arranged beside a nuclear fuel storage rack which has been stored in advance inside the storage pit.

Then, in the method disclosed in Patent Document 2 in which the connecting plate is joined by using pins to connect nuclear fuel storage racks, at a stage that a new nuclear fuel storage rack is suspended beside a nuclear fuel storage rack which has been stored in advance, an operator is required to join the connecting plate by using pins. Thus, there is a fear that an equivalent absorbed radiation dose to the operator will increase. Therefore, it has been desired to develop a method for preventing the rocking of nuclear fuel storage racks or collision of the nuclear fuel storage racks in the event of a large earthquake by connecting the nuclear fuel storage racks more simply and more efficiently.

In view of the above situation, an object of the present invention is to provide a nuclear fuel storage rack connection structure capable of connecting simply and efficiently nuclear fuel storage racks which are stored underwater inside a storage pit and also to provide a nuclear fuel storage rack connection method.

### Means for Solving the Problem

The nuclear fuel storage rack connection structure of the present invention is a nuclear fuel storage rack connection structure for connecting a plurality of nuclear fuel storage racks which are stored so as to be arrayed and arranged underwater inside a storage pit, with nuclear fuel assemblies being accommodated. The nuclear fuel storage rack connection structure is provided with an engagement receiving portion which is installed on an outer circumference of each of the nuclear fuel storage racks and which has an engagement hole opened at least above or an engagement groove. An engagement member is inserted into and engaged with the engagement receiving portion in a vertical direction, thereby connecting the mutually adjacent nuclear fuel storage racks.

In the present invention, another nuclear fuel storage rack is suspended so as to be arrayed and arranged beside a nuclear fuel storage rack stored in advance inside the storage pit, and the engagement member is inserted into and engaged with the engagement receiving portion in the vertical direction, thus making it possible to connect the mutually adjacent nuclear fuel storage racks. As a result, the necessity for conventional troublesome work of joining a connecting plate by using pins is eliminated. Also, the engagement member is only engaged with the engagement receiving portion in the vertical direction, by which the mutually adjacent nuclear fuel storage racks can be connected.

In the nuclear fuel storage rack connection structure of the present invention, the engagement member may be projected outside on a first nuclear fuel storage rack, with one end of the engagement member fixed to an outer circumference of the first nuclear fuel storage rack of the mutually adjacent nuclear fuel storage racks.

In the present invention, the engagement member is projected laterally with one end thereof being fixed to an outer circumference of a nuclear fuel storage rack, and has been already integrally formed into the nuclear fuel storage rack. Therefore, another nuclear fuel storage rack is suspended so as to be arrayed and arranged beside a nuclear fuel storage rack which has been stored in advance inside the storage pit and, at the same time, the engagement member is inserted into and engaged with the engagement receiving portion in the vertical direction, by which mutually adjacent nuclear fuel storage racks can be connected.

In the nuclear fuel storage rack connection structure of the present invention, the engagement receiving portion may be installed on each of the mutually adjacent nuclear fuel storage racks. One end of the engagement member is engaged with the engagement receiving portion of the first nuclear fuel storage rack, while the other end of the engagement member is engaged with the engagement receiving portion of a second nuclear fuel storage rack.

In the present invention, the engagement member is attached in such a manner that both ends thereof are inserted into and engaged with the engagement receiving portions of the mutually adjacent nuclear fuel storage racks in the vertical direction to hang across the mutually adjacent nuclear fuel storage racks. It is, thereby, possible to connect the mutually adjacent nuclear fuel storage racks.

In the nuclear fuel storage rack connection structure of the present invention, the engagement hole or the engagement groove may be provided with a lock receiving portion in which the width thereof gradually increases in the lateral direction from the outside of the nuclear fuel storage rack toward the inside of the nuclear fuel storage rack, and the engagement member may be provided with a lock portion which is engaged with the lock receiving portion and locked.

In the present invention, the lock portion is engaged with the lock receiving portion, by which the engagement receiving portion can be firmly joined with the engagement member. It is, thus, possible to firmly connect the mutually adjacent nuclear fuel storage racks.

In the nuclear fuel storage rack connection structure of the present invention, the engagement hole or the engagement groove may be provided with a taper receiving portion in which the width thereof gradually decreases from an above of the base plate to a below of the base plate, and the engagement member may be provided with a taper portion which is engaged with the taper receiving portion.

In the present invention, the engagement member can be easily inserted into and engaged with the engagement receiving portion in the vertical direction.

In the nuclear fuel storage rack connection structure of the present invention, it is acceptable that the plurality of nuclear fuel storage racks are individually formed into a square box shape and arrayed and arranged so that the corners are brought closer to each other, and the engagement member is provided with a plurality of engagement leg portions which extend below with the upper ends thereof continuing integrally. Each of the engagement leg portions of the engagement member is inserted into and engaged with the engagement receiving portion of each of the nuclear fuel storage racks which are arranged so that the corners are brought closer to each other, thereby connecting the mutually adjacent nuclear fuel storage racks by way of the engagement member.

In the present invention, at a stage that the plurality of nuclear fuel storage racks are arrayed and arranged so that the corners are brought closer to each other, the engagement leg portion of the engagement member is inserted into and engaged with the engagement receiving portion of each of the mutually adjacent nuclear fuel storage racks. Thereby, it is possible to connect the mutually adjacent nuclear fuel storage racks. Further, it is possible to connect, for example, four nuclear fuel storage racks by using one engagement member.

In the nuclear fuel storage rack connection structure of the present invention, the engagement receiving portions may be installed on the nuclear fuel storage rack at a plurality of stages in the vertical direction.

In the present invention, it is possible to connect mutually adjacent nuclear fuel storage racks at a plurality of sites in the vertical direction.

The nuclear fuel storage rack connection method of the present invention is a method for connecting a plurality of nuclear fuel storage racks which are stored so as to be arrayed and arranged underwater inside a storage pit, with nuclear fuel assemblies being accommodated. The above-described nuclear fuel storage rack connection structure is used as a structure for connecting a plurality of nuclear fuel storage racks. In the connection method of the present invention, another nuclear fuel storage rack is suspended so as to be arrayed and arranged beside a nuclear fuel storage rack which has been stored in advance inside the storage pit, and the engagement member is inserted into and engaged with the engagement receiving portion in the vertical direction, thereby connecting mutually adjacent nuclear fuel storage racks.

In the present invention, it is possible to obtain effects by the above-described nuclear fuel storage rack connection structure.

### Effects of the Invention

According to the nuclear fuel storage rack connection structure and the nuclear fuel storage rack connection method of the present invention, another nuclear fuel storage rack is suspended so as to be arrayed and arranged beside a nuclear fuel storage rack which has been stored in advance inside the storage pit, and the engagement member is inserted into and engaged with the engagement receiving portion in the vertical direction. It is, therefore, possible to connect mutually adjacent nuclear fuel storage racks.

Thereby, it is possible to prevent each of the nuclear fuel storage racks stored inside the storage pit from the rocking and the nuclear fuel storage racks stored inside the storage pit from sliding due to their individual responses in the event of a large earthquake. It is also possible to reliably prevent the collision of mutually adjacent nuclear fuel storage racks inside the storage pit. Further, collision of the nuclear fuel storage racks against side walls and the bottom of the storage pit can be reliably prevented by preventing the nuclear fuel storage racks from rocking.

Further, a new nuclear fuel storage rack is suspended beside a nuclear fuel storage rack which has been stored in advance, and also the engagement member is engaged with the engagement receiving portion in the vertical direction, by which mutually adjacent nuclear fuel storage racks can be connected. Therefore, the necessity for conventional troublesome work of joining a connecting plate by using pins is eliminated. The engagement member is only engaged with the engagement receiving portion in the vertical direction, thus making it possible to connect mutually adjacent nuclear fuel storage racks. Thereby, it is possible to simply and efficiently connect the nuclear fuel storage racks with each other and also suppress an equivalent absorbed radiation dose to an operator who is involved in work for connecting the nuclear fuel storage racks.

### BRIEF DESCRIPTION OF DRAWINGS

FIG. 1 is a drawing which shows a storage pit in nuclear fuel storage facilities which stores nuclear fuel storage racks.

FIG. 2 is a drawing which shows a nuclear fuel storage rack.

FIG. 3 is a drawing which shows a nuclear fuel storage rack.

FIG. 4 is a drawing which shows a state that mutually adjacent nuclear fuel storage racks are connected by a nuclear fuel storage rack connection structure of a first embodiment in the present invention.

FIG. 5 is a drawing which shows the nuclear fuel storage rack connection structure of the first embodiment in the present invention.

FIG. 6 covers cross sectional views as viewed in the direction of the line X1-X1 in FIG. 5.

FIG. 7 is a drawing which shows a nuclear fuel storage rack connection method of the first embodiment in the present invention. This drawing shows a state that the nuclear fuel storage rack is suspended and lowered (suspended and raised).

FIG. 8 is a drawing which shows a modified example of the nuclear fuel storage rack connection structure of the first embodiment in the present invention.

FIG. 9 is a drawing which shows a nuclear fuel storage rack connection structure of a second embodiment in the present invention.

FIG. 10 is a drawing which shows a modified example of the nuclear fuel storage rack connection structure of the second embodiment in the present invention.

FIG. 11 is a drawing which shows a modified example of the nuclear fuel storage rack connection structure of the second embodiment in the present invention.

FIG. 12 is a drawing which shows a nuclear fuel storage rack connection structure of a third embodiment in the present invention.

FIG. 13 is a drawing which shows a nuclear fuel storage rack connection method of the third embodiment in the present invention. This drawing shows a state that engagement leg portions of an engagement member are inserted into and engaged with engagement holes of an engagement receiving portion in FIG. 12.

FIG. 14 is a drawing which shows the engagement receiving portion of the nuclear fuel storage rack connection structure of the third embodiment in the present invention.

FIG. 15 is a drawing which shows a modified example of the nuclear fuel storage rack connection structure of the third embodiment in the present invention.

FIG. 16 is a drawing which shows a method for connecting nuclear fuel storage racks by using the nuclear fuel storage rack connection structure given in FIG. 15. This drawing shows a state that engagement leg portions of the engagement member are inserted into and engaged with engagement holes of the engagement receiving portion.

FIG. 17 is a drawing which shows an example where the engagement member is divided into four portions in FIG. 16.

FIG. 18 is a drawing which shows the engagement receiving portion of the nuclear fuel storage rack connection structure given in FIG. 15.

FIG. 19 is a drawing which shows a modified example of the nuclear fuel storage rack connection structure of the third embodiment in the present invention.

FIG. 20 is a drawing which shows a method for connecting nuclear fuel storage racks by the nuclear fuel storage rack connection structure given in FIG. 19. This drawing shows a state in which engagement leg portions of the engagement member are inserted into and engaged with engagement holes of the engagement receiving portion.

FIG. 21 is a drawing which shows the engagement receiving portion of the nuclear fuel storage rack connection structure given in FIG. 19.

FIG. 22 is a drawing which shows a modified example of the nuclear fuel storage rack connection structure of the third embodiment in the present invention.

FIG. 23 is a drawing which shows a state that conventional nuclear fuel storage racks undergo rocking and mutually adjacent nuclear fuel storage racks collide with each other.

### MODE FOR CARRYING OUT THE INVENTION

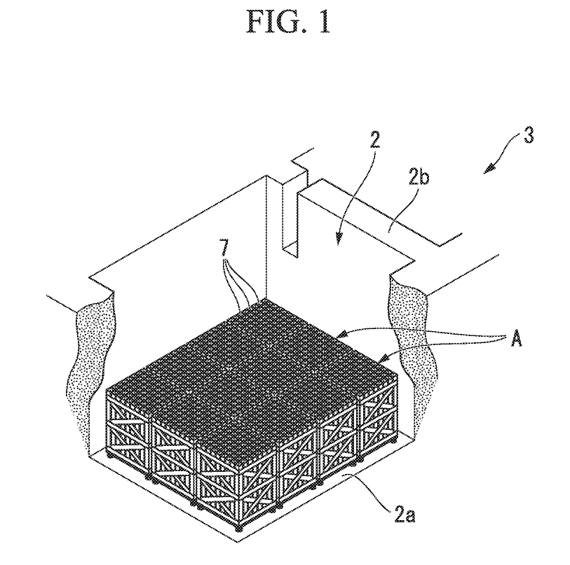

Hereinafter, a description will be given of the nuclear fuel storage rack connection structure and the nuclear fuel storage rack connection method of the first embodiment in the present invention with reference to FIGS. 1 to 7. The present embodiment relates to a nuclear fuel storage rack connection structure which stores and retains used nuclear fuels generated, for example, in a nuclear power plant underwater inside a storage pit in nuclear fuel storage facilities and a nuclear fuel storage rack connection method.

As shown in FIG. 1, the nuclear fuel storage facilities 3 of the present embodiment are provided with a storage pit 2 in which water is pooled to store, underwater, nuclear fuel storage racks A for accommodating used nuclear fuels as nuclear fuel assemblies. Further, inside the storage pit 2, the plurality of nuclear fuel storage racks A are stored so as to be arrayed and arranged on a bottom 2a of the storage pit 2.

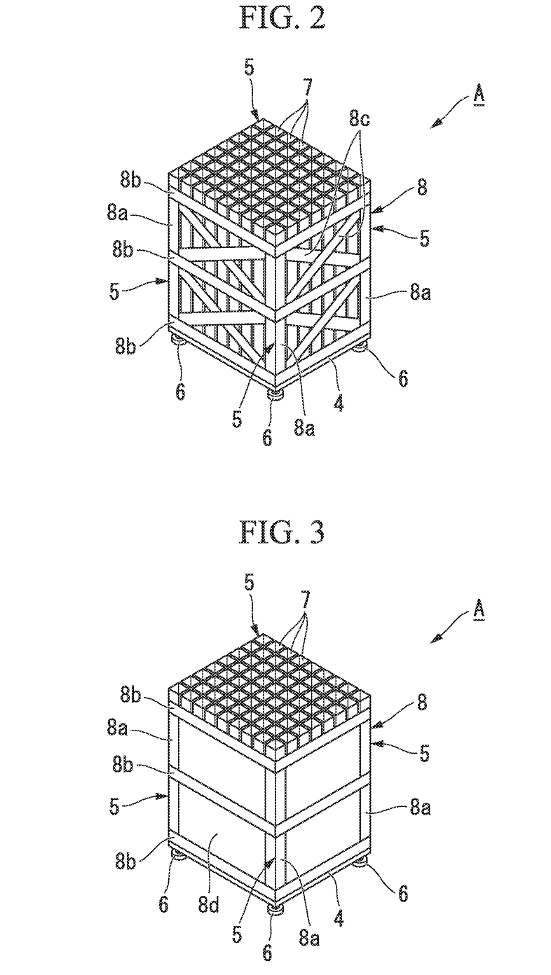

Further, the nuclear fuel storage rack A for accommodating the nuclear fuel assemblies is of a self-sustaining type and formed into a square box shape as with a conventional nuclear fuel storage rack. As shown in FIGS. 1 and 2, the nuclear fuel storage rack A is provided with a base plate 4, a plurality of supporting leg portions 6 which are projected downward, with upper ends continuing to the base plate 4, and installed on a lower face of the base plate 4 and a cell accommodating portion 8 which is installed above the base plate 4 to house and keep a plurality of vertical cells (rack cells) 7. Still further, the cell accommodating portion 8 is erected, with a lower end thereof continuing to the base plate 4. The cell accommodating portion 8 is provided with four columns 8a which are installed on four corners 5 of the base plate 4, cross members (beams) 8b which are installed in a hanging manner by connecting upper ends, intermediate portions and lower ends between mutually adjacent columns 8a, and diagonal members (stays) 8c which are installed within a plane enclosed with the columns 8a and the cross members 8b. As shown in FIG. 3, the nuclear fuel storage rack A may be provided with an outer circumferential plate 8d within a plane enclosed with the columns 8a and the cross members 8b.

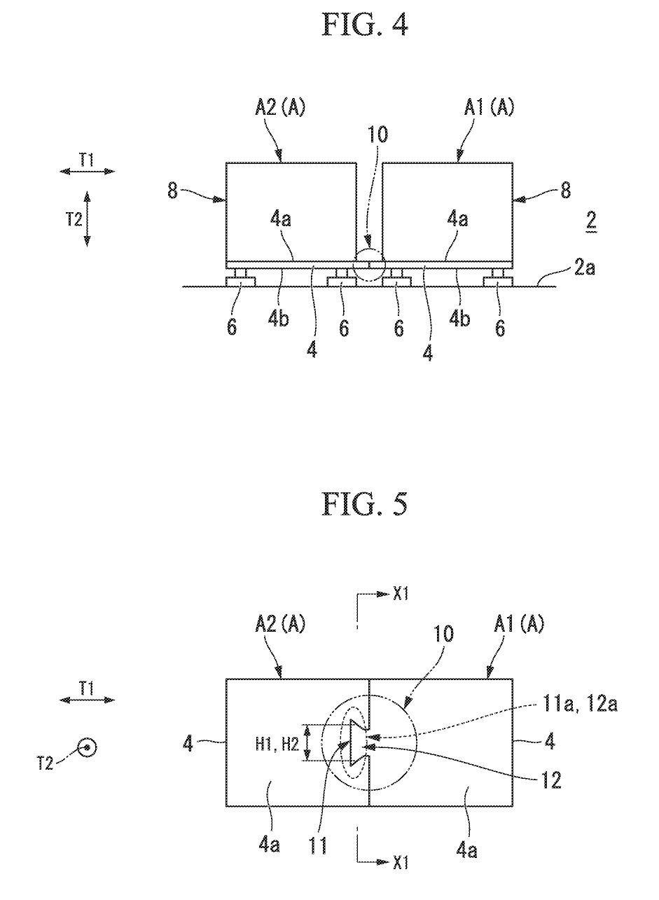

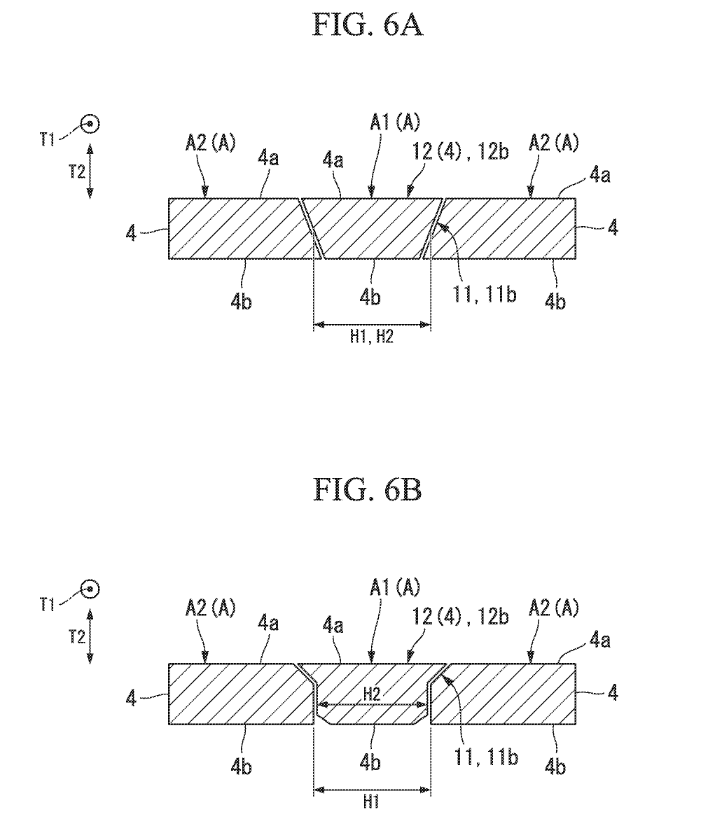

On the other hand, as shown in FIGS. 4 to 6, a connection structure 10 is installed at outer circumferences of the base plates 4 in the nuclear fuel storage racks A (A1, A2) of the present embodiment (on outer circumferences of the nuclear fuel storage racks A (A1, A2)). Also, as shown in FIGS. 5 and 6, the nuclear fuel storage rack connection structure 10 is provided with an engagement receiving portion 11 and an engagement member 12 which is engaged with the engagement receiving portion 11. In the present embodiment, the engagement member 12 is installed on the base plate 4 of the first nuclear fuel storage rack A1 which is adjacent in a state in which a plurality of nuclear fuel storage racks A are arrayed and arranged underwater inside the storage pit 2, and the engagement receiving portion 11 is installed on the base plate 4 of the second nuclear fuel storage rack A2.

The engagement receiving portion 11 is an engagement hole and formed in such a manner as to be recessed from the outer circumference of the base plate 4 to an inside of the base plate 4 and also penetrate from an upper face 4a of the base plate 4 to a lower face 4b thereof. That is, the engagement hole of the engagement receiving portion 11 is formed so as to be open on the outer circumference of the base plate 4 and also open above and below (on the upper face 4a and the lower face 4b). Further, the engagement hole of the engagement receiving portion 11 is provided with a lock receiving portion 11a which is gradually increased in width H1 from the outer circumference of the base plate 4 to the inside (from outside of the nuclear fuel storage rack A1 to inside of the nuclear fuel storage A1 in the lateral direction T1). As shown in FIG. 6, a taper receiving portion 11b is also provided which is gradually decreased in width H1 from the upper face 4a of the base plate 4 to the lower face 4b (from above to below).

On the other hand, as shown in FIGS. 5 and 6, the engagement member 12 is formed so as to be the same in shape and size as the engagement hole of the engagement receiving portion 11 and projected outside in the lateral direction T1, with one end thereof fixed to the outer circumference of the base plate 4. That is, the engagement member 12 of the present embodiment is provided with a lock portion 12a which is integrally formed with the first nuclear fuel storage rack A1 and gradually increased in width H2 from the outer circumference of the base plate 4 to the leading end thereof. Further, the engagement member 12 is provided with a taper portion 12b which is gradually decreased in width H2 from the upper face 4a to the lower face 4b (from above to below). The taper portion 12b is formed so as to be engaged with the taper receiving portion 11b of the engagement receiving portion 11.

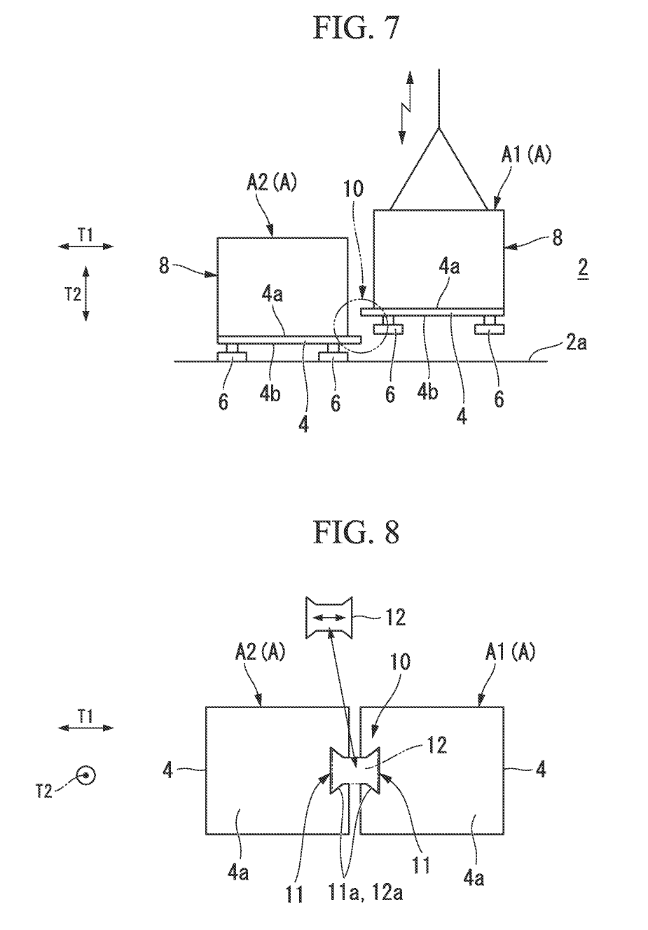

Then, where the mutually adjacent nuclear fuel storage racks A (A1, A2) are connected by using the above-constituted nuclear fuel storage rack connection structure 10 of the present embodiment (in the nuclear fuel storage rack connection method of the present embodiment), as shown in FIG. 7, a new nuclear fuel storage rack (a first nuclear fuel storage rack, another nuclear fuel storage rack) A1 is suspended so as to be arrayed and arranged beside a nuclear fuel storage rack (a second nuclear fuel storage rack) A2 which has been stored in advance inside the storage pit 2. At this time, the first nuclear fuel storage rack A1 is suspended so as to be arrayed and arranged and (at the same time), as shown in FIGS. 4 and 5, the engagement member 12 of the first nuclear fuel storage rack A1 is inserted into and engaged with the engagement receiving portion 11 of the second nuclear fuel storage rack A2 from above (in the vertical direction T2). Thereby, the engagement member 12 engaged with the engagement receiving portion 11 is used to connect the mutually adjacent nuclear fuel storage racks A1, A2. That is, the puzzle-structured connection structure 10 in which the engagement member 12 is inserted into and engaged with the engagement hole of the engagement receiving portion 11 is installed on the nuclear fuel storage racks A1, A2, by which the mutually adjacent nuclear fuel storage racks A1, A2 are connected. Nuclear fuel assemblies are stored underwater inside the storage pit 2, by which temperature elevation of the water will thermally elongate the engagement member 12 to firmly connect the mutually adjacent nuclear fuel storage racks A1, A2.

Then, as described above, the nuclear fuel storage rack A1 is suspended so as to be arrayed and arranged and, at the same time, the mutually adjacent nuclear fuel storage racks A1, A2 are connected. Thereby, the necessity for the conventional troublesome work of joining a connecting plate by using pins is eliminated. The engagement member 12 is only engaged with the engagement receiving portion 11 in the vertical direction T2 (the nuclear fuel storage rack A1 is only suspended and lowered), by which the nuclear fuel storage racks A1, A2 can be connected simply and efficiently. Therefore, it is possible to suppress an increase in equivalent absorbed radiation dose to an operator who is involved in the work of connecting the nuclear fuel storage racks.

Further, at this time, the engagement receiving portion 11 is provided with the taper receiving portion 11b in which the width H1 thereof gradually decreases from the upper face 4a of the base plate 4 to the lower face 4b thereof, and the engagement member 12 is provided with the taper portion 12b. Thus, the nuclear fuel storage rack A1 is suspended so as to be arrayed and arranged and, at the same time, the engagement member 12 is easily engaged with the engagement receiving portion 11. Thereby, the nuclear fuel storage racks A1, A2 can be connected more simply and efficiently.

Then, the engagement member 12 is engaged with the engagement receiving portion 11 to connect the mutually adjacent nuclear fuel storage racks A1, A2. Therefore, it is possible to prevent each of the nuclear fuel storage racks A stored inside the storage pit 2 from rocking and also prevent the nuclear fuel storage racks A stored inside the storage pit 2 from sliding due to their individual responses in the event of a large earthquake. As a result, there is no chance that the mutually adjacent nuclear fuel storage racks A (A1, A2) will collide with each other inside the storage pit 2. Further, rocking of the nuclear fuel storage racks A (A1, A2) is prevented to exclude any chance that the nuclear fuel storage racks A collide against the side walls 2b of the storage pit 2 (refer to FIG. 1).

Still further, as described in the present embodiment, the lock receiving portion 11a, which is gradually increased in width H1 from the outer circumference of the base plate 4 to the inside, is installed on the engagement receiving portion 11, and the lock portion 12b engaged with the lock receiving portion 11a and locked is installed on the engagement member 12. Therefore, the engagement member 12 is reliably engaged with the engagement receiving portion 11 and locked to firmly connect the mutually adjacent nuclear fuel storage racks A1, A2. As a result, it is possible to more reliably prevent rocking of the nuclear fuel storage racks A and sliding of the nuclear fuel storage racks A resulting from their individual responses.

Therefore, in the nuclear fuel storage rack connection structure 10 and the nuclear fuel storage rack connection method of the present embodiment, another nuclear fuel storage rack A1 is suspended so as to be arrayed and arranged beside a nuclear fuel storage rack A2 which has been stored in advance inside the storage pit 2 and also the engagement member 12 is inserted into and engaged with the engagement receiving portion 11 in the vertical direction T2. Thereby, it is possible to connect the mutually adjacent nuclear fuel storage racks A1, A2.

Further, the engagement member is projected outside laterally with one end thereof being fixed to the outer circumference of the nuclear fuel storage rack, and has been already integrally formed into the nuclear fuel storage rack. Therefore, another nuclear fuel storage rack is suspended so as to be arrayed and arranged beside a nuclear fuel storage rack which has been stored in advance inside the storage pit and, at the same time, the engagement member is inserted into and engaged with the engagement receiving portion in the vertical direction, by which the mutually adjacent nuclear fuel storage racks can be connected. Still further, since the engagement receiving portion and the engagement member are simple in structure, existing nuclear fuel storage racks can be processed to easily provide the engagement receiving portion and the engagement member.

Thereby, it is possible to prevent each of the nuclear fuel storage racks A stored inside the storage pit 2 from rocking and the plurality of nuclear fuel storage racks A stored inside the storage pit 2 from sliding due to their individual responses in the event of a large earthquake. As a result, it is possible to reliably prevent collision of the mutually adjacent nuclear fuel storage racks A (A1, A2) inside the storage pit 2. Further, collision of the nuclear fuel storage racks A (A1, A2) against side walls and the bottom of the storage pit 2 can be reliably prevented by preventing the nuclear fuel storage racks A (A1, A2) from rocking.

Further, the necessity for conventional troublesome work of joining a connecting plate by using pins is eliminated, and the engagement member 12 is only engaged with the engagement receiving portion 11 in the vertical direction T2, thus making it possible to connect the mutually adjacent nuclear fuel storage racks A (A1, A2). Thereby, it is possible to simply and efficiently connect the nuclear fuel storage racks A (A1, A2) and also suppress an equivalent absorbed radiation dose to an operator involved in work for connecting the nuclear fuel storage racks.

Still further, the engagement hole of the engagement receiving portion 11 is provided with a lock receiving portion 11a in which the width H1 thereof gradually increases from an outside of the nuclear fuel storage rack A2 to an inside of the nuclear fuel storage rack A2 in the lateral direction T1 of the nuclear fuel storage rack A2, and the engagement member 12 is provided with a lock portion 12a which is engaged with the lock receiving portion 11a and locked. The lock receiving portion 11a is engaged with the lock portion 12a, by which the engagement receiving portion 11 is firmly joined with the engagement member 12. Thus, it is possible to firmly connect the mutually adjacent nuclear fuel storage racks A (A1, A2).

In addition, the engagement hole of the engagement receiving portion 11 is provided with a taper receiving portion 11b in which the width H1 thereof gradually decreases from the above of the base plate 4 to below of the base plate 4, and the engagement member 12 is provided with a taper portion 12b which is engaged with the taper receiving portion 11b. Thereby, the engagement member 12 can be easily inserted into and engaged with the engagement receiving portion 11 in the vertical direction T2.

If such a necessity arises, from a state that the nuclear fuel storage racks A (A1, A2) are kept connected, the nuclear fuel storage rack A1 is suspended and raised, by which the engagement member 12 can be easily disengaged from the engagement receiving portion 11. It is, thus, possible to easily disconnect the mutually adjacent nuclear fuel storage racks A (A1, A2).

A description has been so far given of the nuclear fuel storage rack connection structure and the nuclear fuel storage rack connection method of the first embodiment in the present invention. The present invention shall not be, however, restricted to the above-described first embodiment and may be modified, whenever necessary, in a scope not departing from the gist of the present invention. For example, in the present embodiment, the engagement receiving portion 11 is installed on the nuclear fuel storage rack A2 which has been stored in advance inside the storage pit 2, and the engagement member 12 is integrally formed on the nuclear fuel storage rack A1 which is newly suspended and stored inside the storage pit 2. It is also acceptable that the engagement member 12 is integrally formed on the nuclear fuel storage rack A2 which has been stored in advance, and the engagement receiving portion 11 is installed on the nuclear fuel storage rack A1 which is to be newly suspended.

Further, the engagement receiving portion 11 is engaged with the engagement member 12 to just connect the mutually adjacent nuclear fuel storage racks A1, A2. Therefore, both the engagement receiving portion 11 and the engagement member 12 are installed on each of the nuclear fuel storage racks A (A1, A2), by which each pair of the engagement receiving portion 11 and the engagement member 12 of the mutually adjacent nuclear fuel storage racks A1, A2 may be engaged and connected. Further, a plurality of engagement receiving portions 11 and/or engagement members 12 may be installed on each of the nuclear fuel storage racks A. It is noted that in FIG. 5, a description has been given only of the connection structure in the lateral direction in the drawing. However, the nuclear fuel storage racks A1, A2 are connected in the front-back direction (a direction orthogonal to the lateral direction) in a similar manner, thus making it possible to connect all the nuclear fuel storage racks A.

Still further, the nuclear fuel storage rack connection structure (and the nuclear fuel storage rack connection method) of the present invention are, as a matter of course, applicable to a case where a plurality of nuclear fuel storage racks A are stored inside the storage pit 2 where no water is pooled, in addition to a case where a new nuclear fuel storage rack A1 is arrayed and arranged beside a nuclear fuel storage rack A2 which has been stored in advance underwater inside the storage pit 2.

Further, in the present embodiment, the engagement member 12 is projected outside in the lateral direction T1, with one end of the engagement member 12 being fixed to an outer circumference of the base plate 4. However, as shown in FIG. 8, it is also acceptable that the engagement receiving portion 11 is installed on each of the first nuclear fuel storage rack A1 and the second nuclear fuel storage rack A2, one end of the engagement member 12 is engaged with the engagement receiving portion 11 of the first nuclear fuel storage rack A1, while the other end thereof is engaged with the engagement receiving portion 11 of the second nuclear fuel storage rack A2 to attach the engagement member 12, by which the mutually adjacent nuclear fuel storage racks A1, A2 are connected. That is, it is acceptable that the engagement member 12 is attached by inserting the ends thereof into the engagement receiving portion 11 of each of the mutually adjacent nuclear fuel storage racks A1, A2 in the vertical direction T2 to make an engagement so as to hang across the mutually adjacent nuclear fuel storage racks A1, A2, by which the mutually adjacent nuclear fuel storage racks A1, A2 are connected. Then, in this instance as well, the lock receiving portion 11a, the lock portion 12a, the taper receiving portion 11b, and the taper portion 12b are installed on the engagement receiving portion 11 and the engagement member 12, thus making it possible to obtain effect similar to that of the present embodiment. Further, where the engagement member 12 is formed so as to expand and contract freely, it is possible to make an engagement with the engagement receiving portion 11 (connecting the mutually adjacent nuclear fuel storage racks A1, A2) more easily.

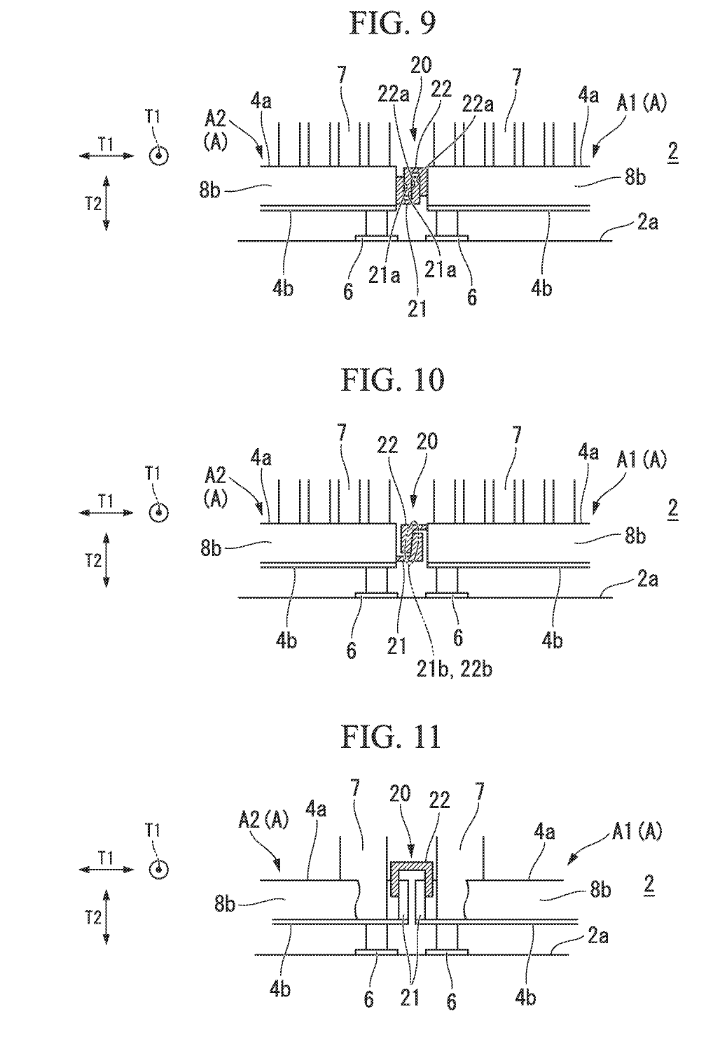

Next, a description will be given of a nuclear fuel storage rack connection structure and a nuclear fuel storage rack connection method of the second embodiment in the present invention with reference to FIG. 9. As with the first embodiment, the present embodiment relates to the nuclear fuel storage rack connection structure and the nuclear fuel storage rack connection method in which an engagement member is installed on a base plate of a first nuclear fuel storage rack of mutually adjacent nuclear fuel storage racks while an engagement receiving portion is installed on a base plate of a second nuclear fuel storage rack, and the engagement member is inserted into the engagement receiving portion to make an engagement, by which the mutually adjacent nuclear fuel storage racks are connected. Therefore, the same reference numerals are given to the same constitutions of the first embodiment, with a detailed description omitted here.

As shown in FIG. 9, a nuclear fuel storage rack connection structure 20 of the present embodiment is provided with an engagement receiving portion 21 and an engagement member 22, each of which is formed (constituted) with a member, the cross section of which is a U-letter shape. Then, the engagement receiving portion 21 is firmly installed on an outer circumference of a base plate 4 in such a manner that an engagement groove formed with a pair of left and right side wall portions 21 a of the member, the cross section of which is a U-shaped, is arranged along the outer circumference of the base plate 4 (of the nuclear fuel storage rack A2) in the lateral direction T1. At this time, the engagement receiving portion 21 is firmly installed on the base plate 4 in such a manner that an opening portion is arranged above between end portions of the pair of left and right side wall portions 21a of the engagement groove.

On the other hand, the engagement member 22 is provided in such a manner that a first side wall portion 22a is firmly installed on the base plate 4 and an end portion of a second side wall portion 22a is installed below. That is, the engagement member 22 and the engagement receiving portion 21 are disposed so as to be upside down.

Then, where the above-constituted nuclear fuel storage rack connection structure 20 of the present embodiment is used to connect the mutually adjacent nuclear fuel storage racks A1, A2, a new nuclear fuel storage rack (a first nuclear fuel storage rack or another nuclear fuel storage rack) A1 is suspended so as to be arrayed and arranged beside a nuclear fuel storage rack (a second nuclear fuel storage rack) A2 which has been stored in advance inside a storage pit 2. Further, the second side wall portion 22a of the engagement member 22 of the first nuclear fuel storage rack A1 is inserted into and engaged with the engagement groove on the engagement receiving portion 21 of the second nuclear fuel storage rack A2 from above (in the vertical direction T2). Thereby, the mutually adjacent nuclear fuel storage racks A1, A2 are connected by the engagement member 22 which is engaged with the engagement receiving portion 21. Further, in FIG. 1, the connection structure 20 is firmly installed in all directions to connect all the nuclear fuel storage racks A.

As described so far, the nuclear fuel storage rack A1 is suspended so as to be arrayed and arranged, and the mutually adjacent nuclear fuel storage racks A1, A2 are connected. Therefore, as with the first embodiment, the necessity for the conventional troublesome work of joining a connecting plate by using pins is eliminated, and the engagement member 22 is only engaged with the engagement receiving portion 21 in the vertical direction T2 (in other words, the nuclear fuel storage rack A1 is only suspended and lowered), by which the nuclear fuel storage racks A1, A2 can be connected simply and efficiently. It is, therefore, possible to suppress an equivalent absorbed radiation dose to an operator involved in the work of connecting the nuclear fuel storage racks.

Further, the engagement member 22 is engaged with the engagement receiving portion 21 to connect the mutually adjacent nuclear fuel storage racks A1, A2. Therefore, it is possible to prevent each of the nuclear fuel storage racks A stored inside the storage pit 2 from rocking or the nuclear fuel storage racks A from sliding due to their individual responses in the event of a large earthquake. Thus, there is no chance that the mutually adjacent nuclear fuel storage racks A (A1, A2) will collide with each other inside the storage pit 2. Further, rocking of the nuclear fuel storage racks A (A1, A2) is prevented to exclude any chance that the nuclear fuel storage racks A will collide against the side walls 2b of the storage pit 2.

Therefore, in the nuclear fuel storage rack connection structure 20 and the nuclear fuel storage rack connection method of the present embodiment, it is possible to obtain the effect similar to that of the first embodiment. Also, another nuclear fuel storage rack A1 is suspended so as to be arrayed and arranged beside a nuclear fuel storage rack A2 which has been stored in advance inside the storage pit 2, the engagement member 22 is inserted into and engaged with the engagement receiving portion 21 in the vertical direction T2, by which the mutually adjacent nuclear fuel storage racks A (A1, A2) can be connected.

It is, thereby, possible to prevent each of the nuclear fuel storage racks A stored inside the storage pit 2 from rocking and the plurality of nuclear fuel storage racks A stored inside the storage pit 2 from sliding due to their individual responses in the event of a large earthquake. It is also possible to reliably prevent collision of the mutually adjacent nuclear fuel storage racks A (A1, A2) inside the storage pit 2. Further, collision of the nuclear fuel storage racks A (A1, A2) against side walls and the bottom of the storage pit 2 can be reliably prevented by preventing the nuclear fuel storage racks A (A1, A2) from rocking.

Further, the necessity for the conventional troublesome work of joining a connecting plate by using pins is eliminated. Also, the engagement member 22 is only engaged with the engagement receiving portion 21 in the vertical direction T2, by which the mutually adjacent nuclear fuel storage racks A1, A2 can be connected. Thereby, the nuclear fuel storage racks A (A1, A2) can be simply and efficiently connected to suppress an equivalent absorbed radiation dose to an operator involved in work for connecting the nuclear fuel storage racks.

If such a necessity arises, from a state that the nuclear fuel storage racks A (A1, A2) are kept connected, the first nuclear fuel storage rack A1 is suspended and raised, by which the engagement member 22 can be easily disengaged from the engagement receiving portion 21. It is, thus, possible to easily disconnect the mutually adjacent nuclear fuel storage racks A (A1, A2).

A description has been so far given of the nuclear fuel storage rack connection structure and the nuclear fuel storage rack connection method of the second embodiment in the present invention. The present invention shall not be, however, restricted to the above-described second embodiment. The present invention including modified examples of the first embodiment may be modified, whenever necessary, in a scope not departing from the gist of the present invention.

For example, as shown in FIG. 10, the engagement receiving portion 21 and the engagement member 22 may be formed with a member, the cross section of which is an L-shaped. Further, it is acceptable that a taper receiving portion 21b in which the width thereof gradually decreases from above to below (in the vertical direction T2) is provided to form an engagement groove of the engagement receiving portion 21, and a taper portion 22b engaged with the taper receiving portion 21b is provided to form the engagement member 22. According to the above-described constitution, as with the first embodiment, the engagement member 22 can be easily inserted into and engaged with the engagement receiving portion 21 in the vertical direction T2.

Further, as shown in FIG. 11, it is acceptable that the engagement receiving portion 21 is formed on each of the mutually adjacent nuclear fuel storage racks A1, A2 (on the base plate 4 of each of the nuclear fuel storage racks A1, A2) so as to extend outside along the outer circumferences which oppose each other, and the engagement member 22, the cross section of which is formed in a U-shaped, is inserted into and engaged with the engagement receiving portions 21 of the mutually adjacent nuclear fuel storage racks A1, A2 from above, by which the mutually adjacent nuclear fuel storage racks A (A1, A2) are connected. Although not illustrated, as with an engagement receiving portion 31 given in FIG. 20, an engagement hole may be formed on the engagement receiving portion 21 and the leading end of the engagement member 22 may be inserted into the engagement hole. In this case as well, it is possible to obtain the effects similar to those of the first embodiment and the second embodiment.

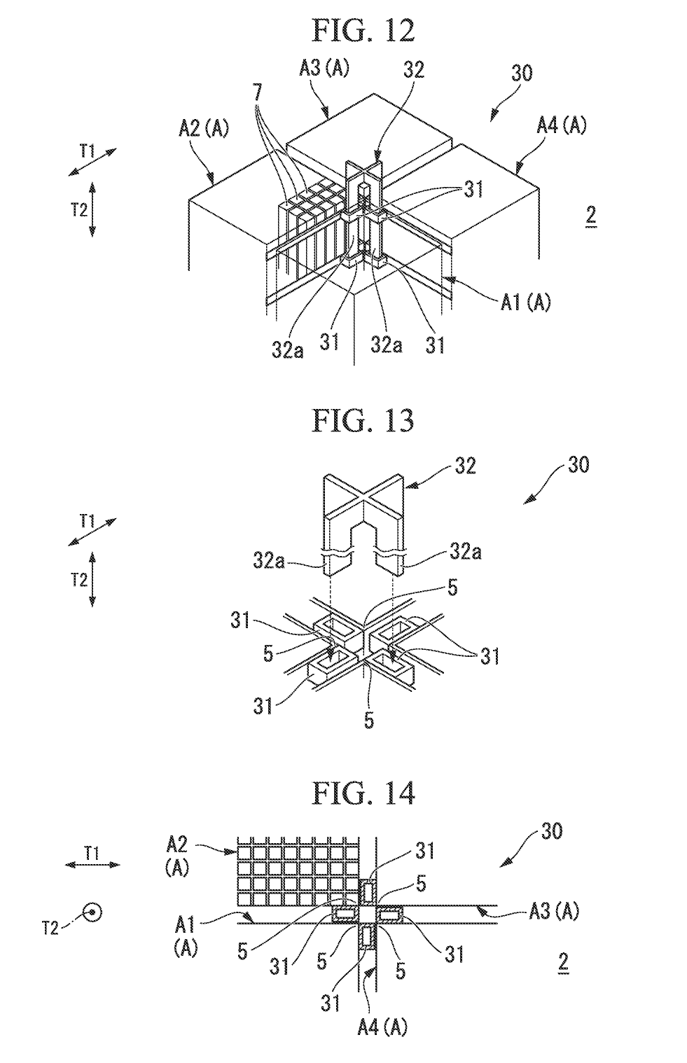

Next, a description will be given of a nuclear fuel storage rack connection structure and a nuclear fuel storage rack connection method of the third embodiment in the present invention with reference to FIGS. 12 to 14. In the present embodiment, the same reference numerals are given to the same constitutions of the first and the second embodiments, with a detailed description omitted here.

As shown in FIGS. 12 to 14, a nuclear fuel storage rack connection structure 30 of the present embodiment is provided with an engagement receiving portion 31 which is formed with a member, the cross section of which is a square shape, or a member, the cross section of which is a U-shaped. Then, the engagement receiving portion 31 is firmly installed by continuing end portions of a pair of left and right side wall portions of the member, the cross section of which is the square shape, to an outer circumference of each of the nuclear fuel storage racks A (the base plate 4 as well as columns 8a and cross members 8b of the cell accommodating portion 8). At this time, the engagement receiving portion 31 is firmly installed in such a manner that an engagement hole is arranged in the vertical direction T2. Further, in the present embodiment, the above-described engagement receiving portions 31 are installed at a plurality of stages (two stages in the present embodiment) in the vertical direction T2 on each of the nuclear fuel storage racks A. And the engagement receiving portion 31 at an upper stage overlaps with that at a lower stage in the vertical direction T2.

On the other hand, the engagement member 32 is provided with four engagement leg portions 32a which extend downward, with the upper end thereof continuing integrally, and formed in a cross shape.

Then, where the above-constituted nuclear fuel storage rack connection structure 30 of the present embodiment is used to connect the mutually adjacent nuclear fuel storage racks A, a new nuclear fuel storage rack A is suspended so as to be arrayed and arranged beside a nuclear fuel storage rack A which has been stored in advance inside the storage pit 2. Further, at this time, four nuclear fuel storage racks A (A1 to A4) are arrayed and arranged, with their corners 5 brought closer. Then, the four nuclear fuel storage racks A (A1 to A4) are arrayed and arranged in this way, and each of the engagement leg portions 32a of the engagement member 32 is inserted into and engaged with each engagement hole of a pair of upper and lower engagement receiving portions 31 on each of the nuclear fuel storage racks A from above (in the vertical direction T2). Thereby, the engagement member 32 engaged with the engagement receiving portion 31 is used to connect the mutually adjacent nuclear fuel storage racks (mutually-adjacent four nuclear fuel storage racks A (A1 to A4).

As described above, the nuclear fuel storage rack A is suspended so as to be arrayed and arranged, and also the engagement member 32 is inserted into the engagement hole from above, by which the mutually adjacent nuclear fuel storage racks A (A1 to A4) are connected. Therefore, as with the first and the second embodiments, the necessity for conventional troublesome work of joining a connecting plate by using pins is eliminated. Also, the engagement member 32 is only engaged with the engagement receiving portion 31 in the vertical direction T2, thus making it possible to simply and efficiently connect the nuclear fuel storage racks A (A1 to A4). Therefore, it is possible to suppress an equivalent absorbed radiation dose to an operator involved in work for connecting the nuclear fuel storage racks.

Further, the engagement member 32 is engaged with the engagement receiving portion 31 to connect the mutually adjacent nuclear fuel storage racks A (A1 to A4). Therefore, it is possible to prevent each of the nuclear fuel storage racks A (A1 to A4) stored inside the storage pit 2 from rocking and the nuclear fuel storage racks A (A1 to A4) from sliding due to their individual responses in the event of a large earthquake. Thus, there is no chance that the mutually adjacent nuclear fuel storage racks A (A1 to A4) will collide with each other inside the storage pit 2. Further, rocking of the nuclear fuel storage racks A (A1 to A4) is prevented to exclude any chance that the nuclear fuel storage racks A will collide against the side walls 2b of the storage pit 2.

Therefore, in the nuclear fuel storage rack connection structure 30 and the nuclear fuel storage rack connection method of the present embodiment, it is possible to obtain the effects similar to those of the first and the second embodiments. Also, another nuclear fuel storage rack A is suspended so as to be arrayed and arranged beside a nuclear fuel storage rack A which has been stored in advance inside the storage pit 2 and also the engagement member 32 is inserted into and engaged with the engagement receiving portion 31 in the vertical direction T2, by which the mutually adjacent nuclear fuel storage racks A (A1 to A4) can be connected.

Thereby, it is possible to prevent each of the nuclear fuel storage racks A (A1 to A4) stored inside the storage pit 2 from rocking and the plurality of nuclear fuel storage racks A (A1 to A4) from sliding due to their individual responses in the event of a large earthquake. As a result, it is possible to reliably prevent collision of the mutually adjacent nuclear fuel storage racks A (A1 to A4) inside the storage pit 2. Further, collision of the nuclear fuel storage racks A (A1 to A4) against side walls and the bottom of the storage pit 2 can be reliably prevented by preventing rocking of the nuclear fuel storage racks A (A1 to A4).

Further, the necessity for the conventional troublesome work of joining a connecting plate by using pins is eliminated. The engagement member 32 is only engaged with the engagement receiving portion 31 in the vertical direction T2, by which the mutually adjacent nuclear fuel storage racks A (A1 to A4) can be connected. Thereby, the nuclear fuel storage racks A (A1 to A4) can be simply and efficiently connected to suppress an equivalent absorbed radiation dose to an operator involved in work for connecting the nuclear fuel storage racks.

Still further, one engagement member 32 is inserted into and engaged with each of the engagement receiving portions 31 of the nuclear fuel storage racks A (A1 to A4) from above, by which the four nuclear fuel storage racks A (A1 to A4) can be connected at once. If such a necessity arises, from a state in which the nuclear fuel storage racks A (A1 to A4) are kept connected, the engagement leg portion 32a of the engagement member 32 is pulled out from the engagement receiving portion 31, by which the mutually adjacent nuclear fuel storage racks A (A1 to A4) can be disconnected easily.

In addition, the engagement receiving portions 31 are installed at a plurality of stages in the vertical direction T2. Thereby, the mutually adjacent nuclear fuel storage racks A (A1 to A4) can be connected at a plurality of sites in the vertical direction T2. It is, thus, possible to connect the mutually adjacent nuclear fuel storage racks A (A1 to A4) more firmly.

A description has been so far given of the nuclear fuel storage rack connection structure and the nuclear fuel storage rack connection method of the third embodiment in the present invention. The present invention shall not be, however, limited to the above third embodiment. The present invention including modified examples of the first and the second embodiments may be modified, whenever necessary, in a scope not departing from the gist of the present invention.

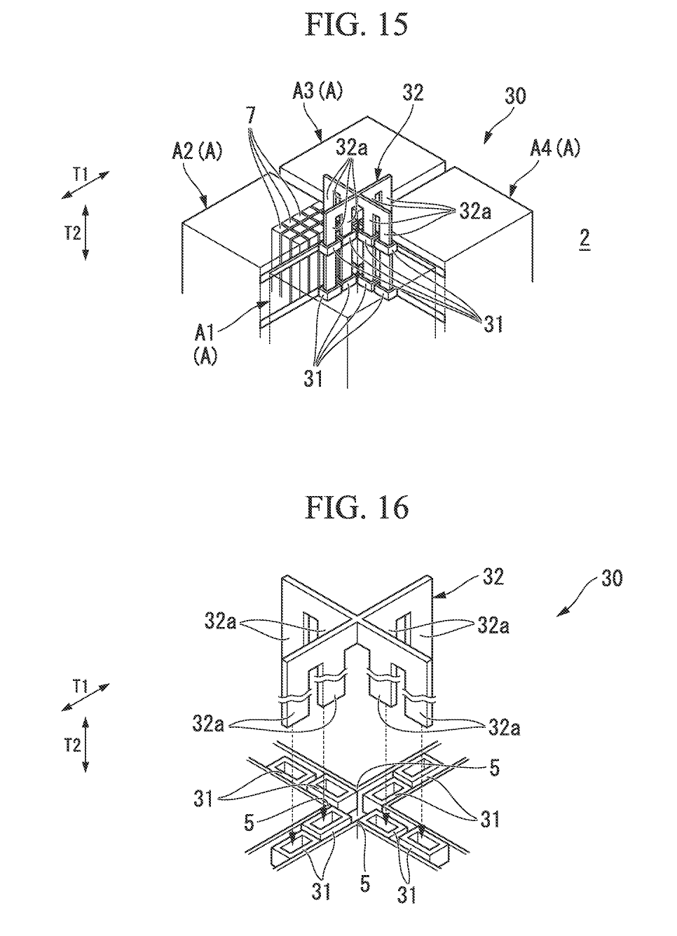

For example, in the present embodiment, the engagement member 32 is provided with the four engagement leg portions 32a. It is, however, not necessary to limit the number of the engagement leg portions 32a. For example, as shown in FIGS. 15, 16 and 18, it is acceptable that two engagement leg portions 32a are provided in each direction (four directions) of the cross-shaped engagement member 32 (a total of eight engagement leg portions) to form the engagement member 32. Then, in this instance, the engagement receiving portion 31 with which each of the engagement leg portions 32a is inserted and engaged from above is provided on each of the nuclear fuel storage racks A (A1 to A4) (the two engagement receiving portions 31 are installed at each stage of each of the nuclear fuel storage racks A (A1 to A2). Thereby, it is possible to connect the mutually adjacent nuclear fuel storage racks A (A1 to A4). Thus, the engagement member 32 having the engagement leg portions 32a which outnumber those of the present embodiment is formed, thus making it possible to connect the nuclear fuel storage racks A (A1 to A4) more firmly.

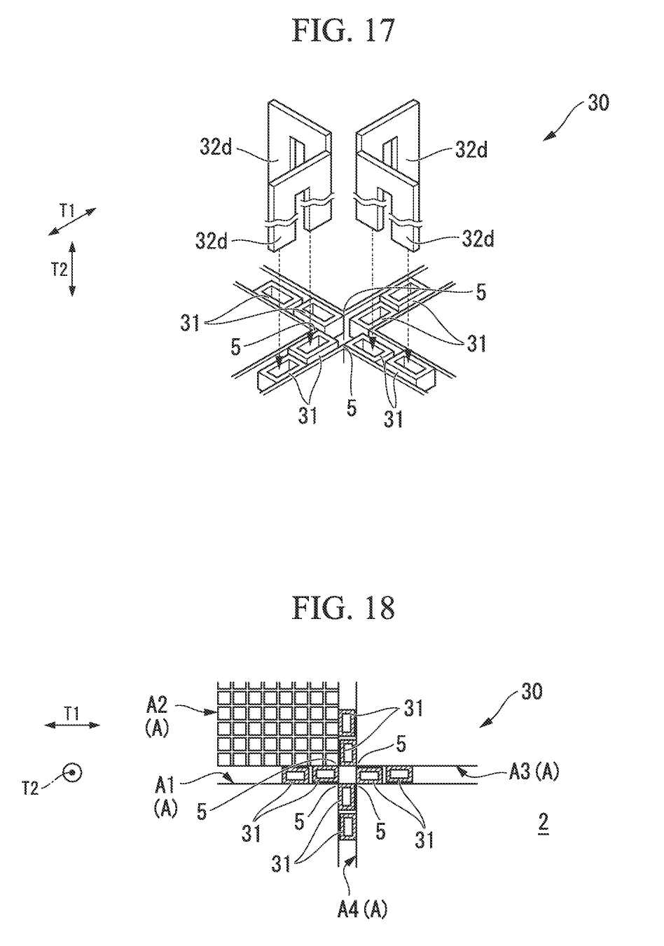

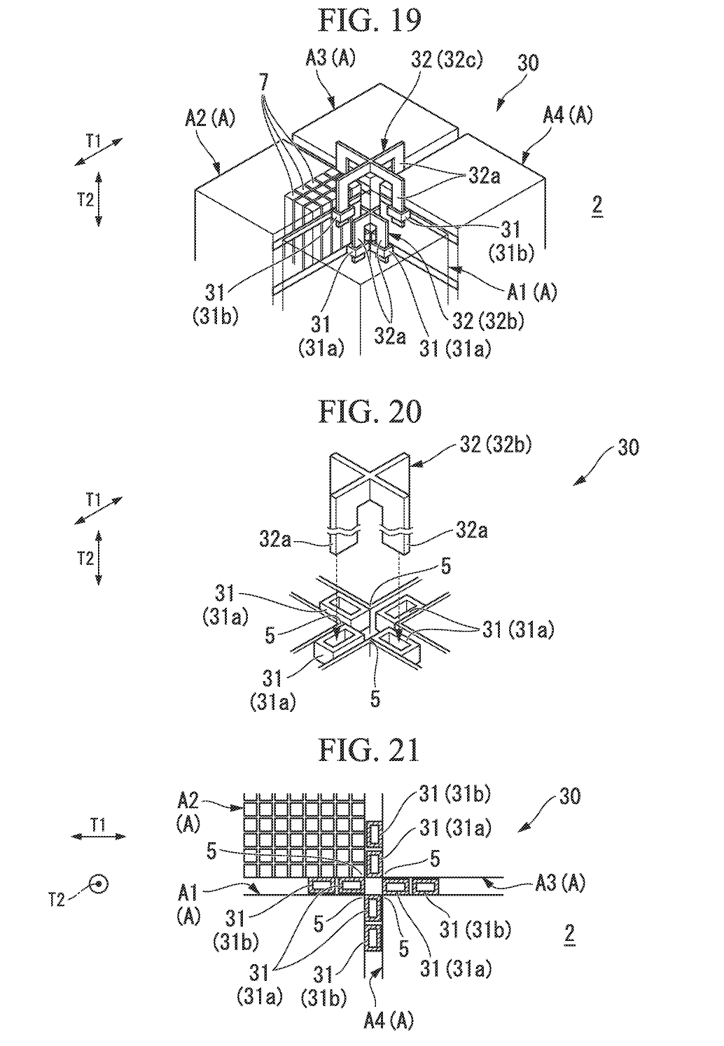

As shown in FIGS. 19 to 21, the engagement member 32 may be inserted into and engaged with the engagement receiving portion 31 at every stage. Accordingly, it is possible to connect the mutually adjacent nuclear fuel storage racks A (A1 to A4) more firmly. In this instance, as shown in FIGS. 19 and 21, a lower-stage engagement receiving portion 31 (31a) with which the engagement leg portion 32a of the lower-stage engagement member 32 (32b) is engaged is deviated outside with respect to the corners 5 which are brought closer to each other, as compared with an upper-stage engagement receiving portion 31 (31b) with which the engagement leg portion 32a of the upper-stage engagement member 32 (32c) is engaged. Thereby, the lower-stage engagement member 32 (32b) can be inserted and engaged in the vertical direction T2. Further, as shown in FIG. 17, the engagement member 32 given in FIG. 16 may be divided into four portions to give engagement members 32d.

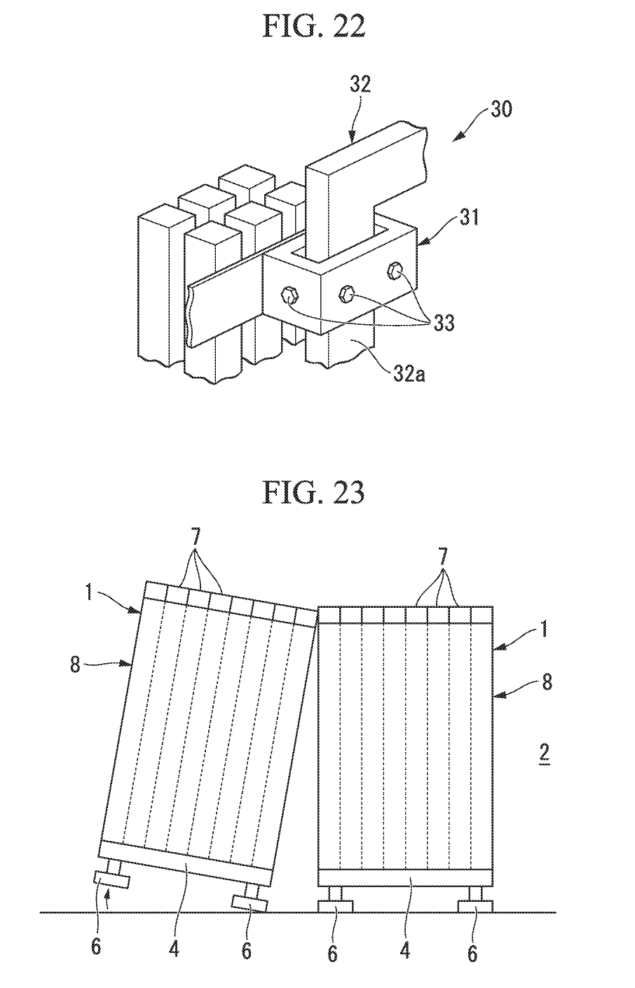

When an operator takes measures to keep of radiation exposure, as shown in FIG. 22, the engagement receiving portion 31 and the engagement member 32 which has been engaged with the engagement receiving portion 31 (the engagement leg portion 32a inserted into and engaged with the engagement hole) may be fixed by using bolts 33 such as push bolts.

Any of the nuclear fuel storage rack connection structures 10, 20, 30 shown in the first embodiment to the third embodiment may be appropriately selected and combined to connect the mutually adjacent nuclear fuel storage racks A.

A description has been so far given of preferred embodiments of the present invention, to which the present invention shall not be, however, restricted. Additions of to constitution, omissions, replacements and other modifications within a scope may be made to the present invention as long as they do not depart from the gist of the present invention. The present invention shall not be restricted to the above description but will be restricted only by the scope of the attached claims.

### INDUSTRIAL APPLICABILITY

The present invention relates to a nuclear fuel storage rack connection structure which connects a plurality of nuclear fuel storage racks stored so as to be arrayed and arranged underwater inside a storage pit, with nuclear fuel assemblies being accommodated. More particularly, the present invention relates to a nuclear fuel storage rack connection structure which is provided with an engagement receiving portion installed on an outer circumference of the nuclear fuel storage rack and having an engagement hole opened above or an engagement groove and in which an engagement member is inserted into and engaged with the engagement receiving portion in a vertical direction to connect the mutually adjacent nuclear fuel storage racks.

According to the present invention, it is possible to simply and efficiently connect the nuclear fuel storage racks which are stored underwater inside a storage pit.

### DESCRIPTION OF REFERENCE NUMERALS

1: Conventional nuclear fuel storage rack
2: Storage pit
2a: Bottom (base plate)
2b: Side wall
3: Nuclear fuel storage facilities
4: Base plate
4a: Upper face
4b: Lower face
5: Corner
6: Supporting leg portion
7: Vertical cell (rack cell)
8: Cell accommodating portion
8a: Column
8b: Cross member
8c: Diagonal member (stay)
8d: Outer circumferential plate
10: Nuclear fuel storage rack connection structure
11: Engagement receiving portion
11a: Lock receiving portion
11b: Taper receiving portion
12: Engagement member
12a: Lock portion
12b: Taper portion
20: Nuclear fuel storage rack connection structure
21: Engagement receiving portion
21a: Side wall portion
22: Engagement member
22a: Side wall portion
30: Nuclear fuel storage rack connection structure
31: Engagement receiving portion
31a: Lower-stage engagement receiving portion
31b: Upper-stage engagement receiving portion
32: Engagement member
32a: Engagement leg portion
32b: Lower-stage engagement member
32c: Upper-stage engagement member
32d: Engagement member
33: Bolt
A, A1, A2, A3, A4: Nuclear fuel storage rack

1. A nuclear fuel storage rack connection structure for connecting a plurality of nuclear fuel storage racks which are stored so as to be arrayed and arranged underwater inside a storage pit, with nuclear fuel assemblies being accommodated,
the nuclear fuel storage rack connection structure including an engagement receiving portion which is installed on an outer circumference of each of the nuclear fuel storage racks and which has an engagement hole opened above or an engagement groove, wherein
an engagement member is inserted into and engaged with the engagement receiving portion in a vertical direction, thereby connecting the mutually adjacent nuclear fuel storage racks.

2. The nuclear fuel storage rack connection structure according to claim 1, wherein
the engagement member is projected outside on a first nuclear fuel storage rack, with one end of the engagement member fixed to an outer circumference of the first nuclear fuel storage rack of the mutually adjacent nuclear fuel storage racks.

3. The nuclear fuel storage rack connection structure according to claim 1 or claim 2, wherein
the engagement receiving portion is installed on each of the mutually adjacent nuclear fuel storage racks,
one end of the engagement member is engaged with the engagement receiving portion of a first nuclear fuel storage rack, while the other end of the engagement member is engaged with the engagement receiving portion of a second nuclear fuel storage rack.

4. The nuclear fuel storage rack connection structure according to claim 1, wherein
the engagement hole or the engagement groove is provided with a lock receiving portion in which the width thereof gradually increases in the lateral direction of the nuclear fuel storage rack from an outside toward an inside, and
the engagement member is provided with a lock portion which is engaged with the lock receiving portion and locked.

5. The nuclear fuel storage rack connection structure according to claim 1, wherein
the engagement hole or the engagement groove is provided with a taper receiving portion in which the width thereof gradually decreases from above to below, and
the engagement member is provided with a taper portion which is engaged with the taper receiving portion.

6. The nuclear fuel storage rack connection structure according to claim 1, wherein
the plurality of nuclear fuel storage racks are individually formed into a square box shape and arrayed and arranged so that the corners are brought closer to each other,
the engagement member is provided with a plurality of engagement leg portions which extend below with the upper ends thereof continuing integrally, and
each of the engagement leg portions of the engagement member is inserted into and engaged with the engagement receiving portion of each of the nuclear fuel storage racks which are arranged so that the corners are brought closer to each other, thereby connecting the mutually adjacent nuclear fuel storage racks by way of the engagement member.

7. The nuclear fuel storage rack connection structure according to claim 1, wherein
the engagement receiving portions are installed on the nuclear fuel storage rack at a plurality of stages in the vertical direction.

8. A method for connecting a plurality of nuclear fuel storage racks which are stored so as to be arrayed and arranged underwater inside a storage pit, with nuclear fuel assemblies being accommodated,
the method for connecting nuclear fuel storage racks in which the nuclear fuel storage rack connection structure described in claim 1 is used as a structure for connecting a plurality of nuclear fuel storage racks, wherein
another nuclear fuel storage rack is suspended so as to be arrayed and arranged beside a nuclear fuel storage rack which has been stored in advance inside the storage pit, and
the engagement member is inserted into and engaged with the engagement receiving portion in the vertical direction, thereby connecting mutually adjacent nuclear fuel storage racks.
